(19) United States
(12) Patent Application Publication
(10) Pub. No.: US 2022/0005207 A1
(43) Pub. Date: Jan. 6, 2022

(54) TRAJECTORY CORRECTION DEVICE, TRAJECTORY CORRECTION METHOD, AND RECORDING MEDIUM

(71) Applicant: NEC Corporation, Minato-ku, Tokyo (JP)

(72) Inventor: Yukie EBIYAMA, (US)

(73) Assignee: NEC Corporation, Minato-ku, Tokyo (JP)

(21) Appl. No.: 17/288,078

(22) PCT Filed: Nov. 2, 2018
(86) PCT No.: PCT/JP2018/040858

§ 371 Date: Apr. 23, 2021

(51) Int. Cl. G06T 7/246; G06T 7/187; G06T 7/33

(52) U.S. Cl. CPC G06T 7/246; G06T 7/187; G06T 2207/30196; G06T 2207/30241; G06T 2207/30232; G06T 7/33

(57) ABSTRACT

A reliability calculation unit calculates parameters representing reliabilities of a plurality of trajectories obtained by tracking one or more objects in a video, a similarity calculation unit calculates a parameter representing a similarity of any two trajectories of the plurality of trajectories, a score calculation unit calculating, as a score, a value obtained by weighting the parameter representing the similarity by the parameter representing the reliability, and a connection unit connects trajectories of the same object among the plurality of trajectories based on the score.

### TECHNICAL FIELD

The present invention relates to a trajectory correction device, a trajectory correction method, and a recording medium, and relates to, for example, a trajectory correction device that corrects a divided trajectory.

### BACKGROUND ART

In related techniques described in PTLs 1 to 4, a person appearing in a video captured by a camera is tracked, and one trajectory (also called locus) is generated for each person. The trajectory of the person thus obtained is used to analyze behavior of the customer in a store or to monitor a business activity of the employee.

### CITATION LIST

### Patent Literature

[PTL 1] JP 2014-186547 A
[PTL 2] JP 2017-40530 A
[PTL 3] JP 2008-250999 A
[PTL 4] WO 2014/125882 A

### SUMMARY OF INVENTION

### Technical Problem

FIG. 12 illustrates an example of a trajectory of a person tracked by the related technique. In a case where a shield is present between a person to be tracked and a camera, the related technique cannot accurately detect the position of the person's area in the video. As a result, as illustrated in FIG. 12, the trajectory of the person may be divided.

In the related technique, the divided trajectories are corrected based on a detection result of a visual features (such as clothing) of the person. However, since how much the detection result of the features regarding the person can be reliable is not taken into consideration, wrong trajectories may be connected.

The present invention has been made in view of the above problem, and an objective of the present invention is to provide a trajectory correction device capable of more accurately correcting a trajectory of an object.

### Solution to Problem

A trajectory correction device according to one aspect of the present invention includes: a reliability calculation means for calculating parameters representing reliabilities of a plurality of trajectories obtained by tracking one or more objects in a video; a similarity calculation means for calculating a parameter representing a similarity of any two trajectories of the plurality of trajectories; a score calculation means for calculating, as a score, a value obtained by weighting the parameter representing the similarity by the parameter representing the reliability; and a connection means for connecting trajectories of the same object among the plurality of trajectories based on the score.

A trajectory correction method according to one aspect of the present invention includes: calculating parameters representing reliabilities of a plurality of trajectories obtained by tracking one or more objects in a video; calculating a parameter representing a similarity of any two trajectories of the plurality of trajectories; calculating, as a score, a value obtained by weighting the parameter representing the similarity by the parameter representing the reliability; and connecting trajectories of the same object among the plurality of trajectories based on the score.

A recording medium according to one aspect of the present invention includes a trajectory tracking program for causing a computer to execute: calculating parameters representing reliabilities of a plurality of trajectories obtained by tracking one or more objects in a video; calculating a parameter representing a similarity of any two trajectories of the plurality of trajectories; calculating, as a score, a value obtained by weighting the parameter representing the similarity by the parameter representing the reliability; and connecting trajectories of the same object among the plurality of trajectories based on the score.

### Advantageous Effects of Invention

According to one aspect of the present invention, a trajectory of an object can be more accurately corrected.

### BRIEF DESCRIPTION OF DRAWINGS

FIG. 1 is a block diagram illustrating a configuration of a tracking device according to a first example embodiment.

FIG. 2 is a diagram for describing smoothing of trajectories.

FIG. 3 illustrates information indicating attributes of a person detected in frames of a video by points on one trajectory.

FIG. 4 is a flowchart illustrating a flow of a trajectory correction method executed by a trajectory correction device according to the first example embodiment.

FIG. 5 illustrates divided four trajectories.

FIG. 6 is a table illustrating motion similarity and attribute similarity.

FIG. 7 is a table illustrating motion reliability and attribute reliability.

FIG. 8 is a table illustrating a score for each pair of trajectories.

FIG. 9 illustrates an example of two trajectories in which four trajectories are connected.

FIG. 10 is a block diagram illustrating a configuration of a trajectory correction device according to a second example embodiment.

FIG. 11 is a diagram illustrating a hardware configuration of a trajectory correction device according to a third example embodiment.

FIG. 12 is a diagram for describing a problem of a related technique.

### EXAMPLE EMBODIMENT

### First Example Embodiment

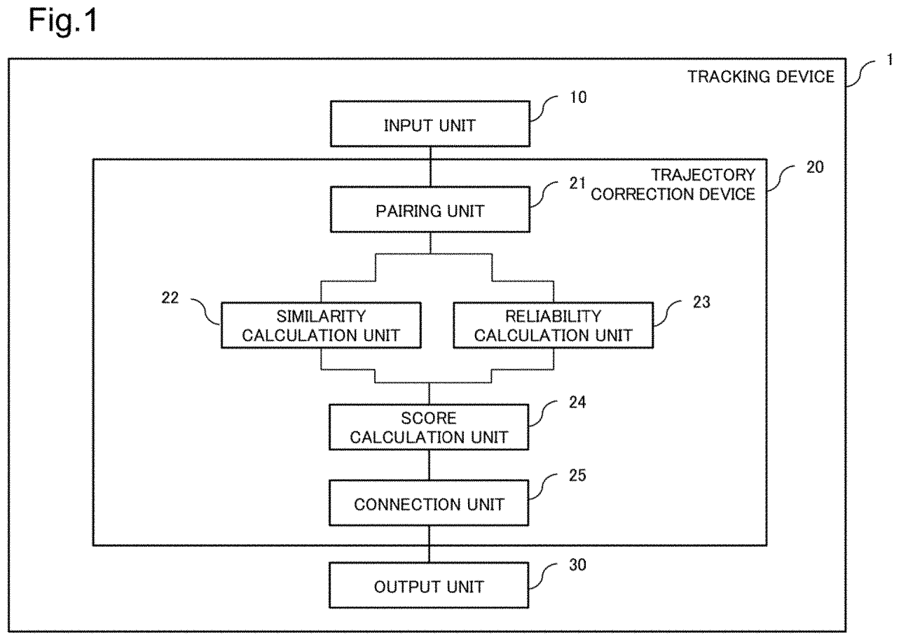

A first example embodiment of the present invention will be described below with reference to FIGS. 1 to 9.

(Tracking Device 1)

FIG. 1 is a block diagram illustrating a configuration of a tracking device 1 according to the present example embodiment. As illustrated in FIG. 1, the tracking device 1 includes an input unit 10, a trajectory correction device 20, and an output unit 30. The tracking device 1 further includes a trajectory generation unit (not illustrated).

The tracking device 1 tracks a person appearing in a video. The tracking device 1 may acquire a video including a person in any manner. The video including a person may be, for example, a video captured by a security camera of a retail store or a video captured by a surveillance camera installed in a public place. The object to be tracked by the tracking device 1 is not limited to a person. The tracking device 1 may track any movable object other than a person.

The unillustrated trajectory generation unit generates trajectory information of the person appearing in the video by analyzing the video acquired by the tracking device 1. The trajectory information includes time-series information indicating a time, an ID, position and attributes of the person. The attributes of the person are, for example, clothes, baggage, sex, age, and the like, which are classified into any categories (for example, colors of clothing). The trajectory generation unit can generate such trajectory information by a general image analysis method. Here, detailed description of a method of analyzing the video and generating the trajectory information by the trajectory generation unit is omitted. Here, in a case where a shield is present between the person to be tracked and the camera, the trajectory generation unit cannot accurately track the position of the person's area in the video. As a result, in the trajectory information, the trajectory of the person may be divided.

The input unit 10 acquires the trajectory information generated by the trajectory generation unit (not illustrated), and transmits the acquired trajectory information to the trajectory correction device 20.

The trajectory correction device 20 includes a pairing unit 21, a similarity calculation unit 22, a reliability calculation unit 23, a score calculation unit 24, and a connection unit 25.

The trajectory correction device 20 receives the trajectory information from the input unit 10 and connects the divided trajectories of the same person. The trajectory correction device 20 transmits the thus corrected trajectory information to the output unit 30. Processing executed by the components of the trajectory correction device 20 will be described in the flow of “trajectory correction method” which will be presented below, and thus description of the processing is omitted here.

The output unit 30 receives the corrected trajectory information from the connection unit 25 of the trajectory correction device 20, and outputs the received trajectory information to an external device. For example, the output unit 30 may output the corrected trajectory information to a display device (not illustrated) or may transmit the corrected trajectory information to a server on a network.

(Calculation of Reliability)

The reliability calculation unit 23 of the trajectory correction device 20 calculates two parameters described below in a flow of a trajectory correction method described below. The reliability calculation unit 23 calculates the number of reliabilities corresponding to two or more similarities calculated by the similarity calculation unit 22 described below. In the present example embodiment and the following example embodiments, the reliability is a value (parameter) indicating a possibility of correctly tracking one object and obtaining one trajectory. The reliability calculation unit 23 may calculate three or more parameters representing the reliabilities. Furthermore, hereinafter, an example in which the reliability calculation unit 23 calculates both the motion reliability and the attribute reliability will be described. However, the reliability calculation unit 23 may calculate two or more parameters representing the motion reliabilities only or two or more parameters representing the attribute reliabilities only.

### (First Parameter: Motion Reliability)

The first parameter represents a variation in the position of the person between frames of the video. The reliability calculation unit 23 smooths the trajectories so as to reduce the variation in the position. For example, the reliability calculation unit 23 may calculate a moving average line of the trajectories.

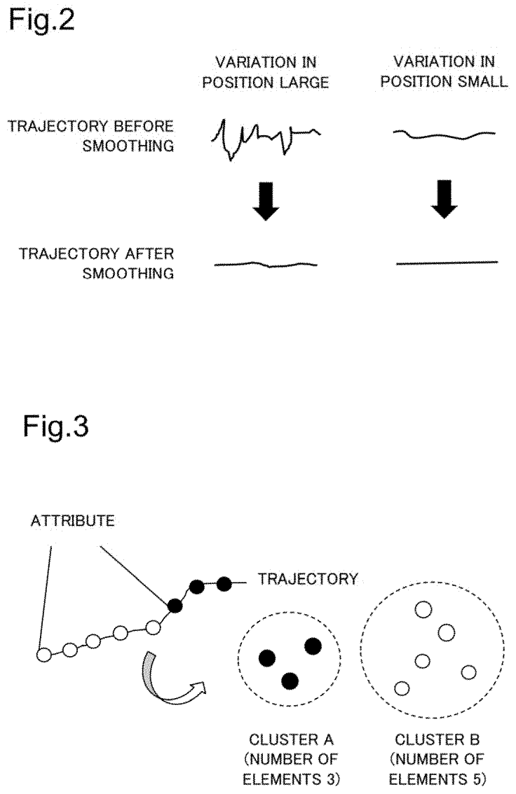

FIG. 2 is a diagram for describing smoothing of the trajectories. FIG. 2 illustrates an example of a trajectory having a large variation in the position and an example of a trajectory having a small variation in the position. As can be seen from the example illustrated in FIG. 2, a change in the length before and after smoothing is larger in the trajectory having a large variation in the position than the trajectory having a small variation in the position.

The reliability calculation unit 23 calculates the first parameter indicating the variation in the position of the person according to the following expression 1.

$$FIRST PARAMETER ( MOTION VARIATION ) = \frac{( \begin{matrix}LENGTH OF TRAJECTORY \\ AFTER SMOOTHING\end{matrix} )}{( \begin{matrix}LENGTH OF TRAJECTORY \\ BEFORE SMOOTHING\end{matrix} )} \qquad [ Expression 1 ]$$

According to the expression 1, in a case where there is no change in the length of the trajectory before and after smoothing by the reliability calculation unit 23, the first parameter has the maximum value of 1. As the first parameter approaches 0, the probability that the trajectory generation unit could not correctly track one person increases. This is because the small value of the first parameter indicates that the variation in the position of the person in the trajectory before and after smoothing is large. The first parameter is called “motion reliability”.

### (Second Parameter: Attribute Reliability)

The second parameter represents a variation in attributes of the person between frames of the video. The reliability calculation unit 23 extracts information indicating attributes of the person in frames of the video from one piece of trajectory information generated by the trajectory generation unit. Then, the reliability calculation unit 23 classifies the extracted attributes into similar attributes to form a cluster.

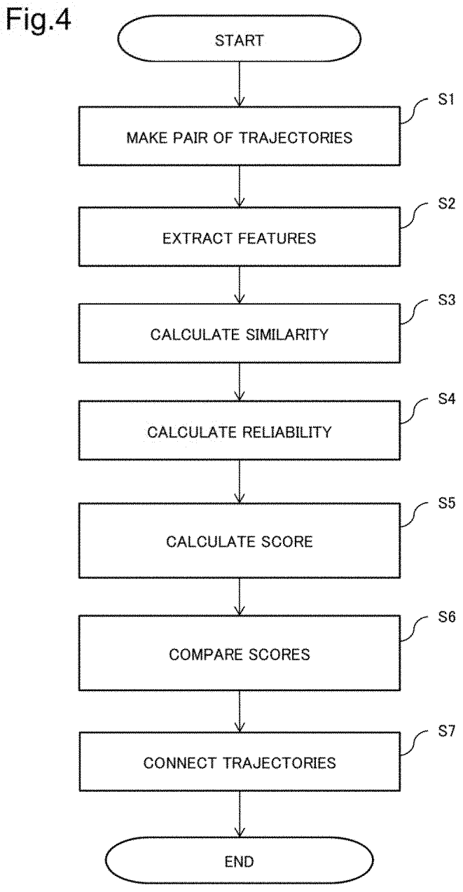

FIG. 3 illustrates the information indicating attributes of the person detected in frames of the video by points on one trajectory. Furthermore, FIG. 3 illustrates a cluster A and a cluster B into which the attributes on the trajectory are classified by similar attributes. The cluster A includes three elements indicated by white circles, and the cluster B includes five elements indicated by black circles.

The reliability calculation unit 23 calculates the second parameter representing the variation in attributes of the person included in the trajectory information according to the expression 2 below.

$$SECOND PARAMETER ( ATTRIBUTE VARIATION ) = \frac{( \begin{matrix}NUMBER OF ELEMENTS \\ OF MAXIMUM CLUSTER\end{matrix} ) }{( NUMBER OF ALL ELEMENTS )} \qquad [ Expression 2 ]$$

According to the expression 2, in a case where all of elements of the attributes of the person extracted from the trajectory information are included in one cluster, the second parameter has the maximum value of 1. As the second parameter approaches 0, the probability that the trajectory generation unit could not correctly track one person increases. This is because the small value of the second parameter indicates that the variation in the attributes of the person is large. The second parameter is called “attribute reliability”.

(Trajectory Correction Method)

Processing executed by each component of the trajectory correction device 20 will be described with reference to FIGS. 4 to 10. FIG. 4 is a flowchart illustrating a flow of a trajectory correction method executed by the trajectory correction device 20.

As illustrated in FIG. 4, the pairing unit 21 acquires the trajectory information from the input unit 10. The trajectory information includes divided trajectories.

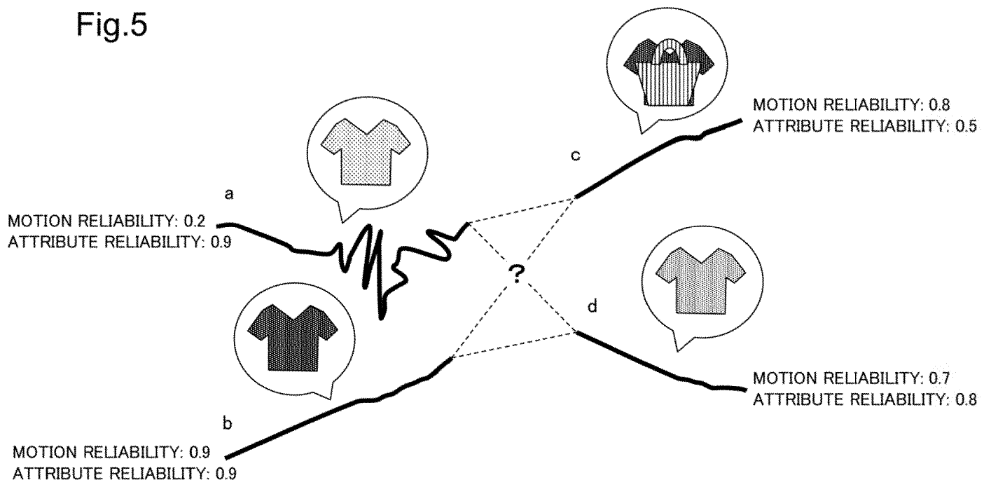

FIG. 5 illustrates an example of divided trajectories. FIG. 5 includes four divided trajectories a to d. The pairing unit 21 determines that the trajectory a should be connected to one of the trajectories c and d, and the trajectory b should be connected to the other of the trajectories c and d based on the time information included in the trajectory information. Therefore, the pairing unit 21 generates (makes pairs of) four combinations of the trajectories, that is, a-c, a-d, b-c, and b-d (S1).

The similarity calculation unit 22 extracts a feature related to a motion of the person and a feature related to an attribute of the person from the trajectory information of the paired two trajectories (S2). The feature related to a motion of the person is, for example, a moving direction or a speed of the person. The feature relating to an attribute of the person is, for example, a histogram representing a color of the clothes of the person.

Next, the similarity calculation unit 22 calculates a similarity of the pair of trajectories generated by the pairing unit 21 (S3). Specifically, the similarity calculation unit 22 calculates a motion similarity of the person and an attribute similarity of the person.

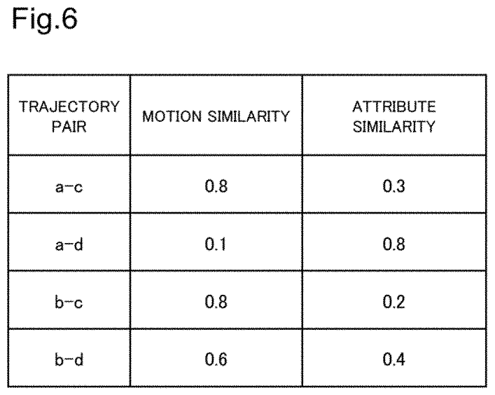

FIG. 6 is a table illustrating motion/attribute similarities (meaning a motion similarity and an attribute similarity) calculated by the similarity calculation unit 22.

The motion similarity illustrated in FIG. 6 represents how naturally the paired two trajectories are connected. The similarity calculation unit 22 may calculate the motion similarity of the person based on, for example, the speed of walking, in addition to a proximity of spatiotemporal distance and a motion direction of the person. More specifically, the similarity calculation unit 22 calculates the motion similarity based on the distance between feature vectors of the person or an angle formed by the feature vectors in a feature space having the proximity of spatiotemporal distance of the person, the motion direction of the person, and the like as parameters. The smaller the distance between the feature vectors or the smaller the angle formed by the feature vectors, the higher the similarity. Detailed description of the similarity calculation method is omitted here.

The attribute similarity illustrated in FIG. 6 indicates how similar attributes of two persons corresponding to the paired two trajectories are to each other. For example, for a pair a-c, the motion similarity of the two persons is 0.8 (1 is the maximum value). For the same pair a-c, the attribute similarity of the two persons is 0.3 (1 is the maximum value). In the example illustrated in FIG. 6, the motion similarity or the attribute similarity of the persons is normalized so as to be represented by a value from 0 to 1.

After step S3, the reliability calculation unit 23 calculates a reliability indicating certainty that the trajectories are obtained by tracking only one person (S4). Specifically, the reliability calculation unit 23 calculates the motion reliability as the above-described first parameter and the attribute reliability as the above-described second parameter. Furthermore, the reliability calculation unit 23 calculates the reliability of each pair of trajectories. As can be seen from the expressions 1 and 2, the first parameter and the second parameter have values from 0 to 1, both inclusive.

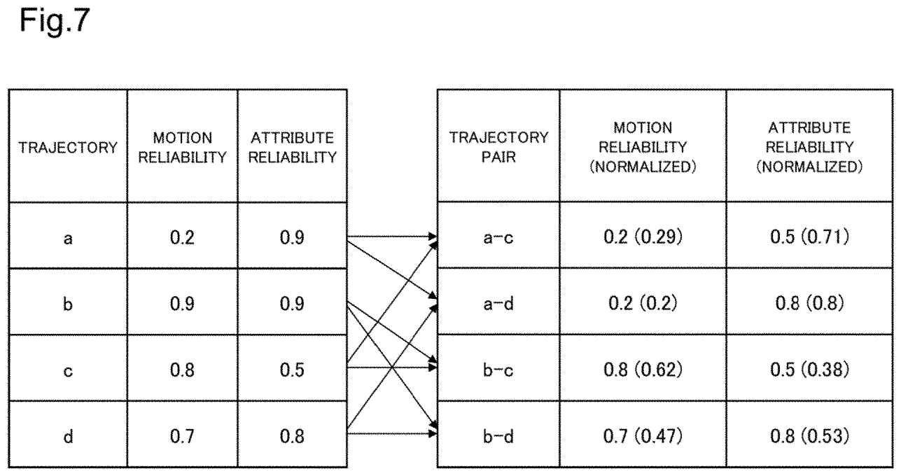

FIG. 7 is a table illustrating the motion/attribute reliabilities (0 to 1) for each trajectory and the motion/attribute reliabilities (0 to 1) for each pair of trajectories. The motion/attribute reliabilities for each trajectory illustrated in FIG. 7 indicates how certain the trajectory generation unit has tracked one person correctly, in other words, how certain the trajectory has been obtained from only one person. The motion reliability is obtained by focusing on the variation in the position of the person (FIG. 2), while the attribute reliability is obtained by focusing on the variation in the attribute of the person.

The motion/attribute reliabilities for each pair of trajectories illustrated in FIG. 7 are calculated by the reliability calculation unit 23 based on the motion/attribute reliabilities of paired two trajectories. Specifically, the motion/attribute reliabilities of each pair of trajectories are smaller motion/attribute reliabilities of the motion/attribute reliabilities of the paired two trajectories. For example, the motion reliability of the trajectory a is 0.2, and the motion reliability of the trajectory c is 0.8. In this case, the motion reliability of the pair a-c of trajectories is the same as the motion reliability of the trajectory a, that is, 0.2.

The reliability calculation unit 23 normalizes the motion/attribute reliabilities for each pair of Trajectories thus calculated. That is, the reliability calculation unit 23 corrects the motion/attribute reliabilities so that the sum of the motion reliability and the attribute reliability becomes 1 for each pair of trajectories. Specifically, the normalized motion/attribute reliabilities are values obtained by dividing the original motion/attribute reliabilities by the sum of the motion/attribute reliabilities. For example, in FIG. 7, for the pair a-c of trajectories, the original motion reliability is 0.2 and the original attribute reliability is 0.5. In this case, the normalized motion reliability is 0.2/(0.2+0.5) (equals 0.29), and the normalized attribute reliability is 0.5/(0.2+0.5) (equals 0.71).

After step S4, the score calculation unit 24 calculates a score for each pair of trajectories using the similarity calculated by the similarity calculation unit 22 and the motion/attribute reliabilities calculated by the reliability calculation unit 23 (S5).

Specifically, the score calculation unit 24 calculates the score for each pair of trajectories according to the following expression 3.

(SCORE)=(MOTION SIMILARITY)×(MOTION RELIABILITY)+(FEATURE SIMILARITY)×(FEATURE RELIABILITY) [Expression 3]

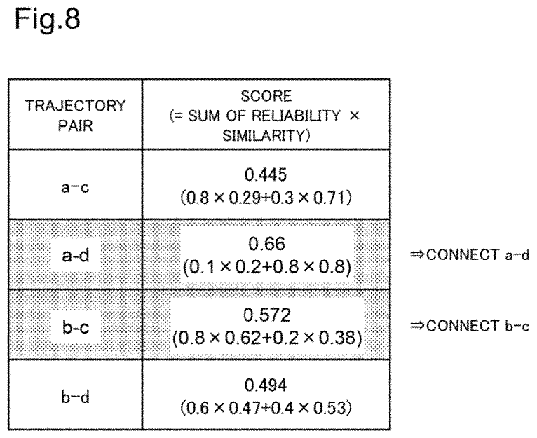

FIG. 8 is a table illustrating the score for each pair of the trajectories calculated by the score calculation unit 24. For example, for the pair a-c of the trajectories, the motion similarity is 0.8 and the motion reliability (normalized) is 0.29. Furthermore, the attribute similarity is 0.3, and the attribute reliability (normalized) is 0.71. Thus, the score for the pair a-c of trajectories is 0.8×0.29+0.3×0.71 (equals 0.445).

After step S5, the connection unit 25 compares the scores (FIG. 8) calculated by the score calculation unit 24 for the respective pairs of trajectories (S7).

The, the connection unit 25 selects the pair of trajectories having the highest score from among all the pairs of trajectories generated by the pairing unit 21. For example, in the example illustrated in FIG. 8, the pair a-d of trajectories having the highest score is selected. Next, the connection unit 25 selects the pair of the trajectories having the highest score from among the remaining pairs of trajectories. In FIG. 8, since only the pair b-c of trajectories except the trajectories a and d remains, the pair b-c of trajectories is selected. The connection unit 25 repeats the series of processing until the partners of all the trajectories are determined.

The connection unit 25 determines the partners of all the trajectories in this manner, and then connects each trajectory with its partner's trajectory (S7). For example, the connection unit 25 may complement the trajectory with its partner's trajectory by a linear trajectory. Alternatively, the connection unit 25 may complement the trajectory and its partner's trajectory by a curved trajectory determined according to the motion direction and speed of the person at one end of the trajectory and the motion direction and speed of the person at one end of the partner's trajectory.

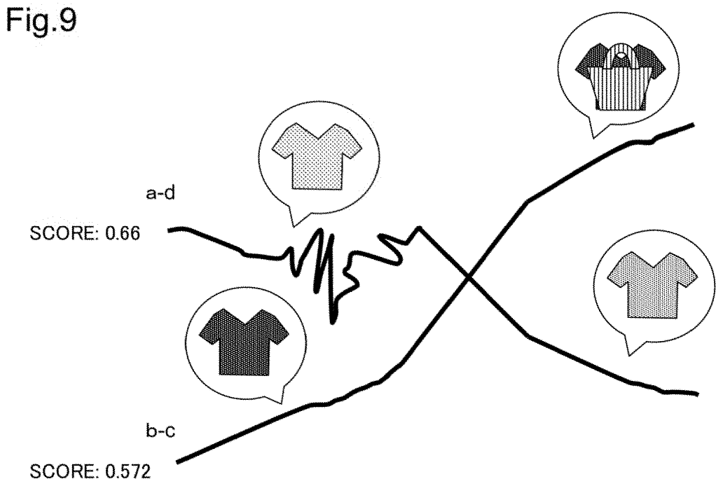

FIG. 9 illustrates an example of two trajectories in which four trajectories are connected. In FIG. 9, the four divided trajectories a to d illustrated in FIG. 5 are connected to partners selected by the connection unit 25. More specifically, the trajectory a illustrated in FIG. 5 is connected to the trajectory d, and the trajectory b illustrated in FIG. 5 is connected to the trajectory c.

The flow of the trajectory correction method ends.

### Effects of Present Example Embodiment

According to the configuration of the present example embodiment, the trajectories of the same object are connected to each other based on the score obtained by weighting the similarity by the reliability. Since not only the similarity between the trajectories but also the reliability indicating the certainty that each trajectory has been obtained by correctly tracking only one object is considered, the trajectory of the object can be more accurately corrected.

### Second Example Embodiment

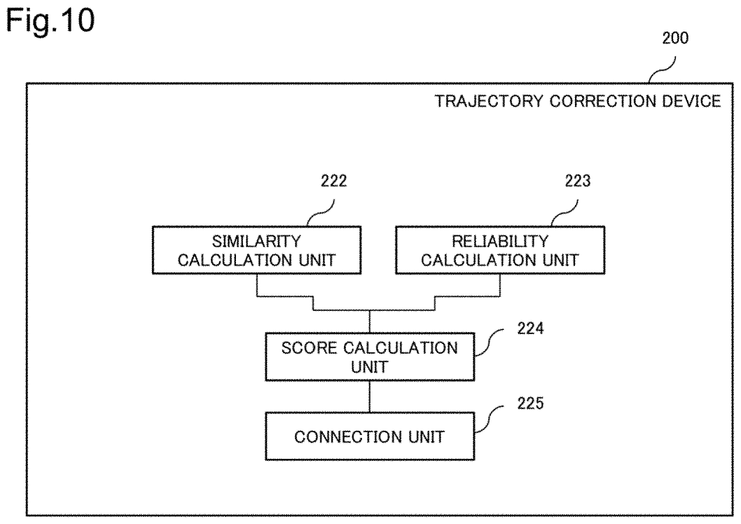

A second example embodiment of the present invention will be described below with reference to FIG. 10.

### (Trajectory Correction Device 200)

FIG. 10 is a block diagram illustrating a configuration of a trajectory correction device 200 according to the present example embodiment. The trajectory correction device 200 acquires a plurality of trajectories obtained by tracking one or more objects in a video, and corrects the trajectories. As illustrated in FIG. 10, the trajectory correction device 200 includes a similarity calculation unit 222, a reliability calculation unit 223, a score calculation unit 224, and a connection unit 225.

The similarity calculation unit 222 calculates a parameter representing a similarity of any two trajectories of the plurality of traj ectories.

The reliability calculation unit 223 calculates parameters representing reliabilities of a plurality of trajectories obtained by tracking one or more objects in a video.

The score calculation unit 224 calculates, as a score, a value obtained by weighting the parameter representing a similarity with the parameter representing a reliability.

The connection unit 225 connects trajectories of the same object among the plurality of trajectories based on the score.

### Effects of Present Example Embodiment

According to the configuration of the present example embodiment, a parameter representing a similarity of any two trajectories among a plurality of trajectories is calculated. Moreover, a score is calculated by weighting the similarity with a parameter representing a reliability. Two trajectories that are highly likely to be trajectories of the same object can be determined based on the score thus calculated. Therefore, the divided trajectories of an object can be more accurately corrected.

### Third Example Embodiment

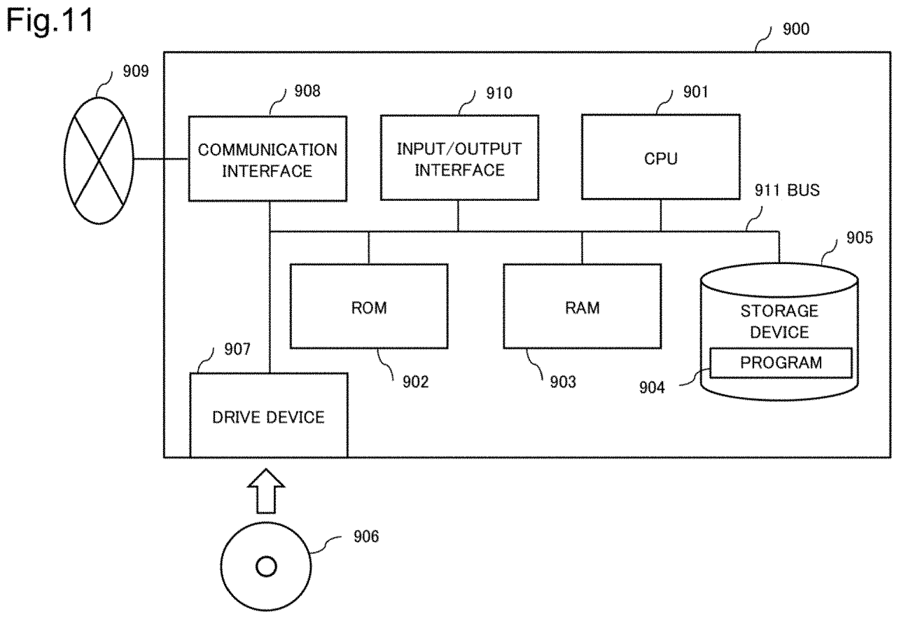

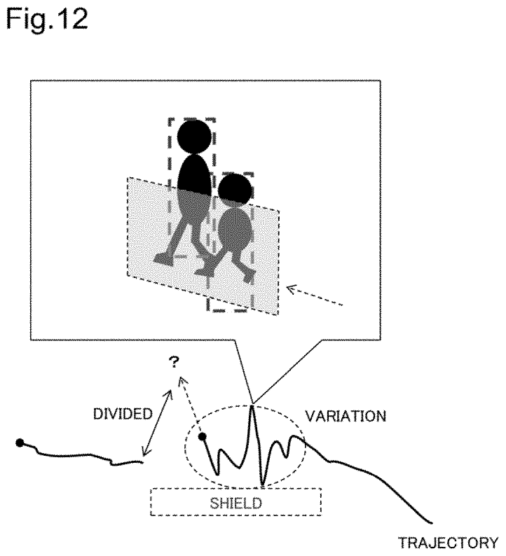

A third example embodiment of the present invention will be described below with reference to FIG. 11.

A trajectory correction device according to the present example embodiment has the same configuration as the trajectory correction device 20 or the trajectory correction device 200 described in the first or second example embodiment.

Some or all of the components of the trajectory correction device according to the present example embodiment are implemented by any combination of an information processing device 900 as illustrated in FIG. 11 and a program, for example. FIG. 11 is a block diagram illustrating an example of a hardware configuration of the information processing device 900.

As illustrated in FIG. 11, the information processing device 900 includes, as an example, the following configurations:
a central processing unit (CPU) 901;
a read only memory (ROM) 902;
a random access memory (RAM) 903;
a program 904 loaded into the RAM 903;
a storage device 905 that stores the program 904;
a drive device 907 that reads/writes data from/to a recording medium 906;
a communication interface 908 connected to a communication network 909;
an input/output interface 910 that inputs/outputs data; and
a bus 911 connecting the components.

Each component of each device described in each example embodiment is implemented by the CPU 901 acquiring and executing the program 904 for implementing the operation of each component. The program 904 for implementing the functions of the components of the devices is stored in advance in the storage device 905 or the ROM 902, for example, and is loaded to the RAM 903 and executed by the CPU 901 as necessary. The program 904 may be supplied to the CPU 901 through the communication network 909 or may be stored in the recording medium 906 in advance and the drive device 907 may read and supply the program to the CPU 901.

### Effects of Present Example Embodiments

According to the configurations of the present example embodiments, the device described in any of the above example embodiments is implemented as hardware. Therefore, similar effects to the effects described in any of the example embodiments can be exhibited.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1 Tracking device
2 Trajectory correction device
20 Trajectory correction device
21 Pairing unit
22 Similarity calculation unit
23 Reliability calculation unit
24 Score calculation unit
25 Connection unit
222 Similarity calculation unit
223 Reliability calculation unit
224 Score calculation unit
225 Connection unit

What is claimed is:

1. A trajectory correction device comprising:
a memory configured to store instructions; and
at least one processor configured to execute the instructions to perform:
calculating parameters representing reliabilities of a plurality of trajectories obtained by tracking one or more objects in a video;
calculating a parameter representing a similarity of any two trajectories of the plurality of trajectories;
calculating, as a score, a value obtained by weighting the parameter representing the similarity by the parameter representing the reliability; and
connecting trajectories of the same object among the plurality of trajectories based on the score.

2. The trajectory correction device according to claim 1, wherein
the reliability is a value indicating a possibility of correctly tracking one object and obtaining one trajectory.

3. The trajectory correction device according to claim 2, wherein
the reliability is higher as a variation in the trajectory is smaller.

4. The trajectory correction device according to claim 2, wherein
the reliability is higher as a variation in a-characteristic associated with the trajectory is smaller.

5. The trajectory correction device according to claim 1, wherein
the similarity represents how similar characteristics regarding objects respectively associated with the two trajectories are to each other.

6. A trajectory correction method comprising:
calculating parameters representing reliabilities of a plurality of trajectories obtained by tracking one or more objects in a video;
calculating a parameter representing a similarity of any two trajectories of the plurality of trajectories;
calculating, as a score, a value obtained by weighting the parameter representing the similarity by the parameter representing the reliability; and
connecting trajectories of the same object among the plurality of trajectories based on the score.

7. A non-transitory recording medium recording a trajectory tracking program for causing a computer to execute:
calculating parameters representing reliabilities of a plurality of trajectories obtained by tracking one or more objects in a video;
calculating a parameter representing a similarity of any two trajectories of the plurality of trajectories;
calculating, as a score, a value obtained by weighting the parameter representing the similarity by the parameter representing the reliability; and
connecting trajectories of the same object among the plurality of trajectories based on the score.
